(19) United States
(12) Patent Application Publication
(10) Pub. No.: US 2018/0229973 A1
(43) Pub. Date: Aug. 16, 2018

(54) ELEVATOR RECUPERATOR

(71) Applicants: Frédéric BEAUCHAUD, Gien (FR); OTIS ELEVATOR COMPANY, Farmington, CT (US)

(72) Inventors: Frédéric BEAUCHAUD, Coullons (FR); Franck DOMINGUEZ, Ouzouer sur Loire (FR)

(21) Appl. No.: 15/751,522

(22) PCT Filed: Aug. 31, 2015
(86) PCT No.: PCT/IB2015/001895

§ 371 Date: Feb. 9, 2018

(51) Int. Cl. B66B 13/28; B66B 11/02; B66B 5/00; B66B 13/30

(52) U.S. Cl. CPC B66B 13/28; B66B 13/301; B66B 5/0087; B66B 11/0246

(57) ABSTRACT

An elevator car is provided having a floor, an elevator car door, and a sill, wherein a gap forms between the sill and a landing when the elevator car is positioned at the landing. A recuperator is connected below the elevator car, wherein at least a portion of the recuperator is configured to automatically move from a first position to a second position such that the at least a portion of the recuperator spans the gap. The recuperator is configured such that the at least a portion of the recuperator moves from the first position to the second position when the elevator car door opens and the at least a portion of the recuperator moves from the second position to the first position when the elevator car door closes.

### BACKGROUND

The subject matter disclosed herein generally relates to recuperators and, more particularly, to recuperators and methods of operation for elevators.

Elevators are a means of efficiently moving numbers of passengers between different floors within a building. When the passengers enter into the car of an elevator small objects may fall or be dropped by the passengers (e.g., keys, coins, etc.). At times, these objects may fall through a gap that exists between a sill of the elevator car and a sill of the landing, i.e., a gap in the floor between the landing and the elevator car. When this happens, a mechanic may be called and required to go in the pit of the hoistway or elevator shaft in order to retrieve the objects. Such objects may also cause hazards within the pit of the elevator shaft. Thus, preventing objects from falling between the sill of the elevator car and the landing when passengers are entering and/or exiting the elevator may be desirable.

### SUMMARY

According to one embodiment, an elevator car is provided. The elevator car includes a floor, an elevator car door, and a sill, wherein a gap forms between the sill and a landing when the elevator car is positioned at the landing. A recuperator is connected below the elevator car, wherein at least a portion of the recuperator is configured to automatically move from a first position to a second position such that the at least a portion of the recuperator spans the gap. The recuperator is configured such that the at least a portion of the recuperator moves from the first position to the second position when the elevator car door opens and the at least a portion of the recuperator moves from the second position to the first position when the elevator car door closes.

In addition to one or more of the features described above, or as an alternative, further embodiments of the elevator car may include that the at least a portion of the recuperator is configured to slidably move between the first position and the second position.

In addition to one or more of the features described above, or as an alternative, further embodiments of the elevator car may include that the at least a portion of the recuperator is a box arranged on rails.

In addition to one or more of the features described above, or as an alternative, further embodiments of the elevator car may include that the at least a portion of the recuperator configured to rotatably move between the first position and the second position.

In addition to one or more of the features described above, or as an alternative, further embodiments of the elevator car may include that the at least a portion of the recuperator is a recuperator panel.

In addition to one or more of the features described above, or as an alternative, further embodiments of the elevator car may include an access panel configured to enable access to the recuperator from within the elevator car.

In addition to one or more of the features described above, or as an alternative, further embodiments of the elevator car may include that the recuperator is operationally connected to the elevator car door.

According to another embodiment, a method of operating an elevator is provided. The method includes opening an elevator car door, operating a recuperator such that at least a portion of the recuperator moves from a first position to a second position when the elevator car door opens, closing the elevator car door, and operating the recuperator such that the at least a portion of the recuperator moves from the second position to the first position when the elevator car door closes.

In addition to one or more of the features described above, or as an alternative, further embodiments of the method may include that the recuperator is operationally connected to the elevator car door.

In addition to one or more of the features described above, or as an alternative, further embodiments of the method may include accessing the recuperator to retrieve any objects therein.

In addition to one or more of the features described above, or as an alternative, further embodiments of the method may include engaging a maintenance mode of the elevator prior to accessing the recuperator.

In addition to one or more of the features described above, or as an alternative, further embodiments of the method may include that the accessing is performed from within an elevator car.

In addition to one or more of the features described above, or as an alternative, further embodiments of the method may include that the accessing is performed through a floor of an elevator car.

In addition to one or more of the features described above, or as an alternative, further embodiments of the method may include that the recuperator is maintained in the first position when the elevator is moved between floors of a building.

In addition to one or more of the features described above, or as an alternative, further embodiments of the method may include that the operation of the recuperator is automatically performed when the elevator car door is opened or closed.

Technical effects of embodiments of the present disclosure include an automatic recuperator configured to deploy or activate when the doors of an elevator car open, and retract or deactivate when the doors close. Further technical effects include providing a mechanism for retrieving objects within the recuperator without a person needing to enter the elevator shaft, let alone enter the pit of the elevator shaft.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may incorporate embodiments disclosed herein;

FIG. 2 is an enlarged schematic view of a gap between an elevator car sill and a landing sill;

FIG. 3A is a schematic illustration of a recuperator in accordance with an embodiment of the present disclosure with the recuperator in a first position;

FIG. 3B is a schematic illustration of the recuperator of FIG. 3A moving from the first position to a second position;

FIG. 3C is a schematic illustration of the recuperator of FIG. 3A in the second position and capturing a falling object;

FIG. 3D is a schematic illustration of the recuperator of FIG. 3A moving from the second position back to the first position;

FIG. 3E is a schematic illustration of a technician accessing the recuperator of FIG. 3A when in a maintenance mode;

FIG. 4A is a schematic illustration of a recuperator in accordance with another embodiment of the present disclosure with the recuperator in a first position;

FIG. 4B is a schematic illustration of a portion of the recuperator of FIG. 4A moving from the first position to a second position;

FIG. 4C is a schematic illustration of the recuperator of FIG. 4A in the second position and capturing a falling object;

FIG. 4D is a schematic illustration of a portion of the recuperator of FIG. 4A moving from the second position back to the first position;

FIG. 4E is a schematic illustration of a technician accessing the recuperator of FIG. 4A in a maintenance mode;

FIG. 5 is a process of operating an elevator in accordance with a non-limiting embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

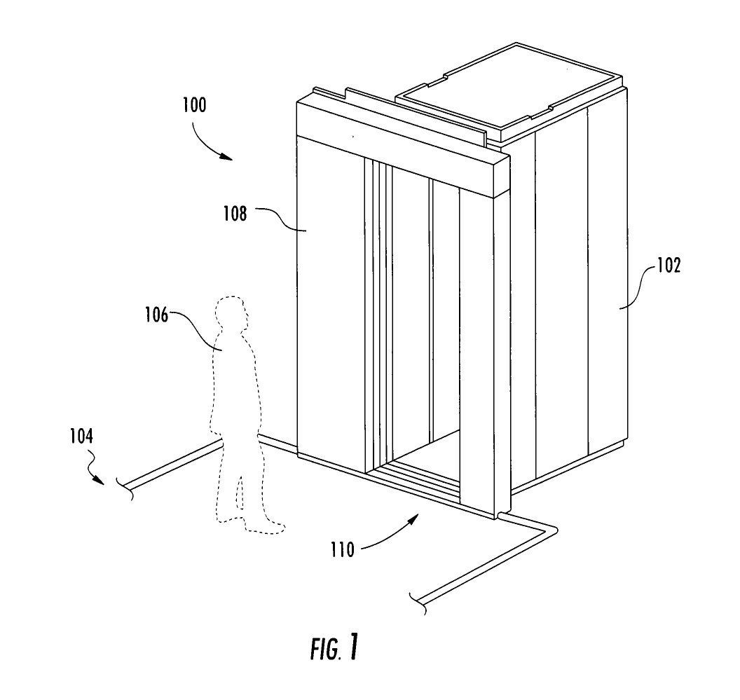

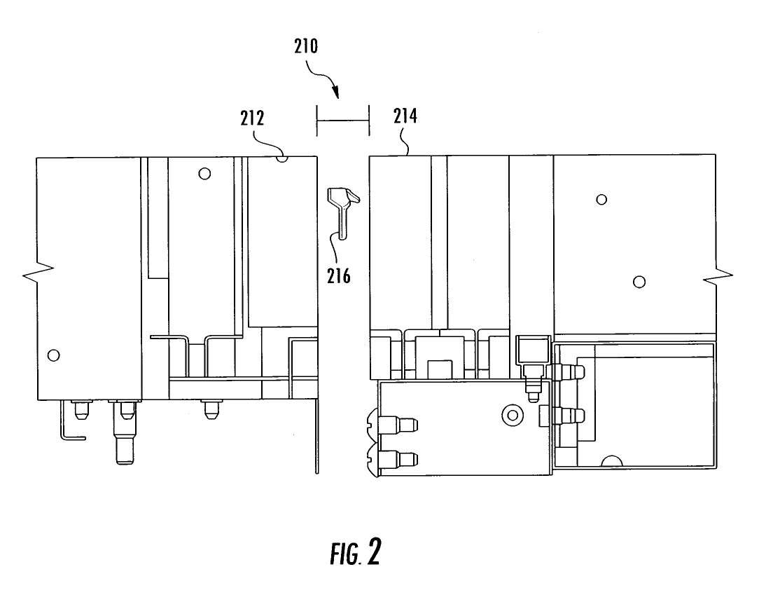

FIG. 1 is a schematic illustration of an elevator system 100 that may incorporate embodiments disclosed herein. As shown in FIG. 1, an elevator car 102 is located at a landing 104. The elevator car 102 may be called to the landing 104 by a passenger 106 that desires to travel to another floor within a building. When the elevator car 102 reaches the landing 104, one or more elevator doors 108, including elevator car doors and landing doors, may open, allowing the passenger 106 to enter or exit the elevator car 102. Located between the elevator car 102 and the landing 104 may be a gap 110 (see FIG. 2 for more detail) that is between the elevator car doors and the landing doors. A floor of the landing 104 and a floor of the elevator car 102 may each include a sill that are level but include the gap 110 therebetween. When a passenger 106 enters or exits the elevator car 102, the passenger 106 may drop or lose items through the gap 110.

Turning now to FIG. 2, an enlarged side view of a gap 210 between a sill of a landing 212 and an elevator car sill 214 is shown. The landing sill 212, in FIG. 2, is located on the left side of the image and the elevator car sill 214 is located on the right side of the image. Between the landing sill 212 and the elevator car sill 214 is the gap 210. In some elevator system configurations, the gap 210 may be about 1.18 inches (30 mm). The size of the gap 210 allows for the elevator car to move within an elevator shaft without damaging the elevator car, but also allows for small objects, e.g., object 216, to fall through the gap 210. When an object 216 falls through the gap 210, the object 216 may fall to the bottom of the elevator shaft, e.g., the pit. Items in the pit may need to be retrieved, cleaned up, and/or cleared out for various reasons, including retrieval of lost objects from passengers.

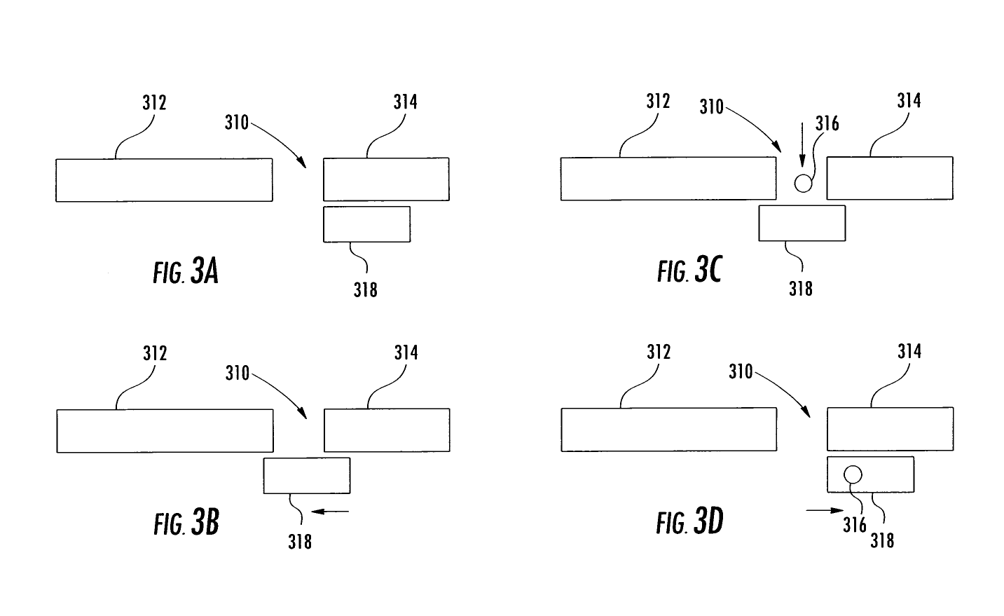

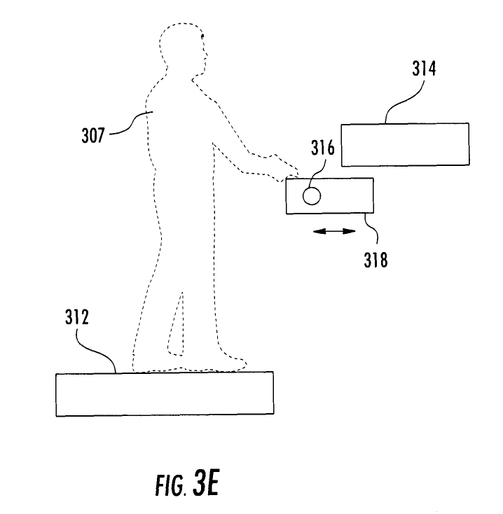

Turning now to FIGS. 3A-3E, various schematic views of a recuperator in accordance with a non-limiting embodiment of the present disclosure are shown. As shown, a recuperator 318 is attached to the elevator car below the elevator car sill 314 and configured to operate or move between a first position and a second position. FIGS. 3A-3D show an operational mode of the recuperator 318 and FIG. 3E shows a maintenance mode of the recuperator 318 wherein objects may be retrieved from the recuperator 318. The recuperator 318 of this non-limiting embodiment may be configured as an open-topped box that is located on rails or other sliding mechanisms that allow translating movement of the recuperator box 318 relative to the elevator car sill 314 between the first position and the second position. In some non-limiting embodiments, the recuperator 318 may be configured to span or extend the length of the gap such that at any position of the gap the recuperator may be configured to capture any dropped objects.

In FIG. 3A, the recuperator 318 is in a first position, such as a disengaged or retracted position. The recuperator 318 is in the first position during movement of the elevator car within the elevator shaft. That is, the recuperator 318 is in the first position when the elevator car is moving between landings or floors within the elevator shaft.

When the elevator car stops at a floor to allow passengers to enter or exit, as the elevator car doors open the recuperator 318 moves or translates to a second position, as shown in FIG. 3B. As shown in FIG. 3B, the recuperator 318 translates such that the recuperator 318 spans or covers the gap 310 between the landing sill 312 and the elevator car sill 314.

As shown in FIG. 3C, an object 316 may fall into and through the gap 310 and may be captured by the recuperator 318. This is because when the elevator is stopped and the elevator doors are opened to allow passengers to enter or exit the elevator car, the recuperator 318 is in the second position, such as an engaged or deployed position.

Finally, as shown in FIG. 3D, as the elevator car doors close, the recuperator 318 is translated back to the first position, and contains the object 316. The elevator car may then move to another floor, and be deployed again to the second position the next time the elevator car doors open.

In accordance with some non-limiting embodiments of the present disclosure, the recuperator 318 may be configured to automatically operate with the operation of the elevator doors such that the recuperator 318 only moves from the first position to the second position when the elevator doors open. The recuperator then stays in the second position as long as the elevator car doors are open. Then, when the elevator car doors close, the recuperator automatically moves from the second position to the first position. In some non-limiting embodiments, the recuperator may be operationally coupled to the elevator car doors and in other non-limiting embodiments the recuperator may be independently operated from the elevator car doors. That is, in some embodiments, the operation of the elevator car doors may mechanically, or otherwise, operate the recuperator. In other embodiments, when the doors open, a motor or other device may be configured to operate the recuperator.

Turning now to FIG. 3E, a maintenance mode of operation of the recuperator 318 is shown. As shown in FIG. 3E, the landing sill 312 and the elevator car sill 314 are not level. That is, in the maintenance mode of operation, the elevator car doors and the landing doors may be opened even when the elevator car is not level with the landing. In the maintenance mode, the elevator car (along with the elevator car sill 314) may be moved to a position such that a technician 307 may gain access to the recuperator 318. The technician 307 may manually operate the recuperator 318 from the first position to the second position to retrieve the object 316 from the recuperator 318. Alternatively, an automatic operation may be performed, such as pressing a button or other type of actuation to force the recuperator 318 from the first position to the second position. After retrieval of the object 316 from the recuperator 318, the technician 307 may move the recuperator 318 back to the first position and then return the elevator to the normal operational mode (as described with respect to FIGS. 3A-3D).

In some non-limiting embodiments, the recuperator may be operationally and/or mechanically connected to the elevator car doors, such that the recuperator and its position is controlled or driven by the elevator car doors. In alternative embodiments, the recuperator may be electronically controlled by a controller or other device that is configured to actuate or control the recuperator to move from the first position to the second position when the elevator car doors are opened and vice versa when the elevator car doors are closed. Those of skill in the art will appreciate that other types of control mechanisms and/or devices may be used without departing from the scope of the present disclosure.

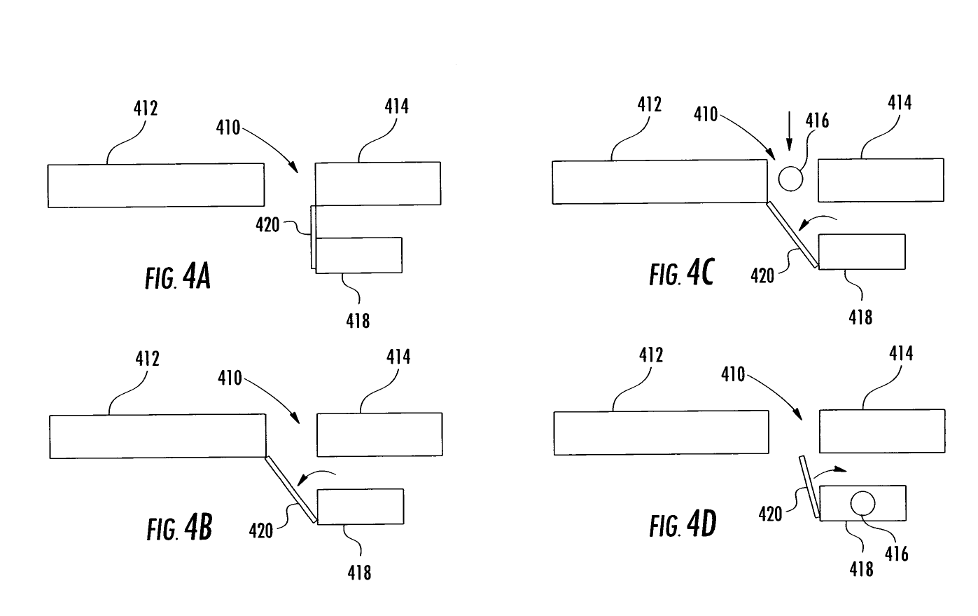

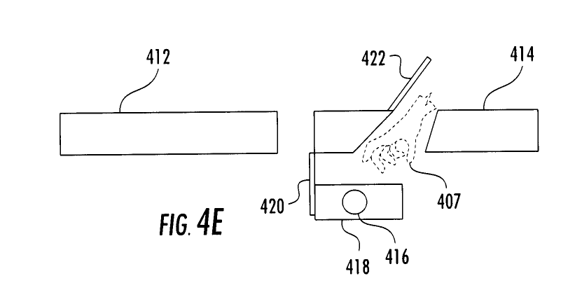

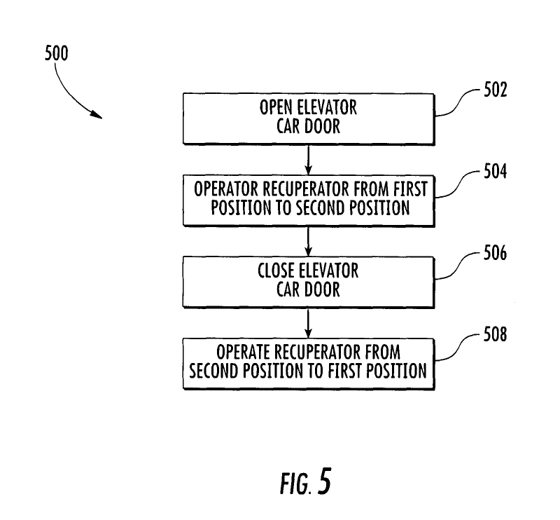

Turning now to FIGS. 4A-4E, various schematic views of another recuperator in accordance with a non-limiting embodiment of the present disclosure is shown. As shown, a recuperator 418 is attached to the elevator car below the elevator car sill 414 and configured to operate between a first position and a second position. FIGS. 4A-4D show an operational mode of the recuperator 418 and FIG. 4E shows a maintenance mode of the recuperator 418. The recuperator 418 may be configured as an open-sided box with portion of the recuperator 418 being moveable between the first and second positions. For example, a recuperator panel 420 or other hinged mechanism may be operable between the first position and the second position. That is, the recuperator panel 420 may be closed in the first position and opened in the second position, as described below.

In FIG. 4A, the recuperator 418 is in a first position, such as a disengaged or closed position, i.e., the recuperator panel 420 is in a closed position. The recuperator 418 is in the first position during movement of the elevator car within the elevator shaft. For example, the recuperator 418, and the recuperator panel 420, is in the first position when the elevator car is moving between landings or floors within the elevator shaft.

When the elevator car stops at a floor to allow passengers to enter or exit, as the elevator car doors open the recuperator panel 420 of the recuperator 418 moves or opens to a second position, as shown in FIG. 4B. As shown in FIG. 4B, the recuperator panel 420 of the recuperator 418 opens or moves such that the recuperator panel 420 spans or covers the gap 410 between the landing sill 412 and the elevator car sill 414. It will be appreciated that, in some embodiments, the panel 420 may include side walls that are perpendicular to the surface of the panel 420 and located at the ends of the gap 410, in the length-wise direction, i.e., into and out of the page of FIG. 4B. The side walls may be extendable panels, such as elastic or accordion shaped, or may be solid walls/panels that are configured to slide into and out of the recuperator 418, or may take any other configuration.

As shown in FIG. 4C, an object 416 may fall into and through the gap 410 and may be captured by the recuperator 418 when the object 416 contacts the recuperator panel 420 and is directed into the recuperator 418. This is because when the elevator is stopped and the elevator doors are opened to allow passengers to enter or exit the elevator car, the recuperator panel 420 of the recuperator 418 is in the second position, such as an open or deployed position. In some embodiments, if side walls are installed with the panel 420, any object that falls into the gap 410 may be prevented from falling or rolling off an edge of the panel 420 and into the elevator shaft.

Finally, as shown in FIG. 4D, as the elevator car doors close, the recuperator panel 420 of the recuperator 418 is moved back to the first position, and contains the object 416 within the recuperator 418. The elevator car may then move to another floor, and the recuperator may be operated again the next time the elevator car doors open.

Similar to the embodiment described with respect to FIGS. 3A-3D, the recuperator 418, and the recuperator panel 420 thereof, may be configured to automatically operate with the operation of the elevator doors such that the recuperator only opens from the first position to the second position when the elevator doors open. The recuperator panel 420 then stays in the second position as long as the elevator car doors are open. Then, when the elevator car doors close, the recuperator panel 420 of the recuperator 418 automatically closes from the second position to the first position.

Turning now to FIG. 4E, a maintenance mode of operation of the recuperator 418 is shown. As shown in FIG. 4E, the landing sill 412 and the elevator car sill 414 are level, although in this embodiment this is not required. In the maintenance mode, a technician 407 may access the contents of the recuperator 418, i.e., object 416, though an access panel 422. Access panel 422 may be a trapdoor, panel, floor tile, or other mechanism that is installed into the floor and/or sill of the elevator car. The technician 407 may manually open the access panel 422 to retrieve the object 416. As will be appreciated by those of skill in the art, access panel 422 enables a technician to retrieve object 416 from within the elevator car.

Although access panel 422 is shown as a hinged door, those of skill in the art will appreciate that access panel 422 may take other forms. For example, access panel 422 may be a sliding panel or may be a removable floor tile/panel of the elevator car.

Turning now to FIG. 5, a process of operating an elevator in accordance with a non-limiting embodiment is shown. Process 500 generally describes the operation of an elevator in normal operating mode. That is, process 500 may be performed when the elevator is in service and conveying passengers between floors.

When the elevator reaches a floor and the doors open (step 502), passengers may be able to enter and exit an elevator car. When the elevator car doors open, a recuperator or portion thereof may be operated from a first position to a second position (step 504). For example, in one non-limiting embodiment, the elevator car door may mechanically operate a recuperator to slide from a first position below the elevator car to a second position such that the recuperator spans a gap between the elevator car and the landing such that objects falling into the gap may be captured within the recuperator. Then, as the elevator car doors close (step 506) the recuperator is operated from the second position back to the first position (step 508).

Advantageously, embodiments described herein provide a mechanism for capturing objects that may fall between an elevator car sill and a landing sill of an elevator shaft. Embodiments disclosed herein provide an automatic mechanism (recuperator) that is engaged or opened when the elevator car doors are opened and disengaged or closed when the elevator car doors are closed. Thus, when the doors are closed, the recuperator does not interfere with the normal operation of the elevator.

Further, advantageously, embodiments described herein allow for easy retrieval of objects that may be dropped in a gap between an elevator car and a landing. Further, advantageously, in accordance with some embodiments, there may be no need to enter the elevator shaft to retrieve fallen objects. Moreover, in accordance with some embodiments, the objects may be retrieved from within the elevator car.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although shown and described with a limited number of configurations of operation of the recuperator during normal operation and in maintenance mode, those of skill in the art will appreciate that other mechanisms and/or processes of movement of the recuperator may be employed without departing from the scope of the present disclosure. For example, the entire recuperator may be hinged such that the recuperator rotates from the first position to the second position. Further, the recuperator is not limited to a box, as shown, but rather may include bags, nets, and/or other types of containers without departing from the scope of the present disclosure.

Accordingly, the present disclosure is not to be seen as limited by the foregoing description, but is only limited by the scope of the appended claims.

1. An elevator car comprising:
a floor;
an elevator car door;
a sill, wherein a gap forms between the sill and a landing when the elevator car is positioned at the landing; and
a recuperator connected below the elevator car, wherein at least a portion of the recuperator is configured to automatically move from a first position to a second position such that the at least a portion of the recuperator spans the gap,
wherein the recuperator is configured such that the at least a portion of the recuperator moves from the first position to the second position when the elevator car door opens and the at least a portion of the recuperator moves from the second position to the first position when the elevator car door closes.

2. The elevator of claim 1, wherein the at least a portion of the recuperator is configured to slidably move between the first position and the second position.

3. The elevator of claim 1, wherein the at least a portion of the recuperator is a box arranged on rails.

4. The elevator of claim 1, wherein the at least a portion of the recuperator configured to rotatably move between the first position and the second position.

5. The elevator of claim 1, wherein the at least a portion of the recuperator is a recuperator panel.

6. The elevator of claim 1, further comprising an access panel configured to enable access to the recuperator from within the elevator car.

7. The elevator of claim 1, wherein the recuperator is operationally connected to the elevator car door.

8. A method of operating an elevator, the method comprising:
opening an elevator car door;
operating a recuperator such that at least a portion of the recuperator moves from a first position to a second position when the elevator car door opens;
closing the elevator car door; and
operating the recuperator such that the at least a portion of the recuperator moves from the second position to the first position when the elevator car door closes.

9. The method of claim 8, wherein the recuperator is operationally connected to the elevator car door.

10. The method of claim 8, further comprising:
accessing the recuperator to retrieve any objects therein.

11. The method of claim 10, further comprising engaging a maintenance mode of the elevator prior to accessing the recuperator.

12. The method of claim 10, wherein the accessing is performed from within an elevator car.

13. The method of claim 10, wherein the accessing is performed through a floor of an elevator car.

14. The method of claim 8, wherein the recuperator is maintained in the first position when the elevator is moved between floors of a building.

15. The method of claim 8, wherein the operation of the recuperator is automatically performed when the elevator car door is opened or closed.
